(19) United States
(12) Patent Application Publication
(10) Pub. No.: US 2010/0313216 A1
(43) Pub. Date: Dec. 9, 2010

(54) Integration of television advertising with internet shopping

(76) Inventor: Gutman Levitan, Stamford, CT (US)

Correspondence Address: Gutman Levitan, 122 EGRET DRIVE, JUPITER, FL, 33458, US

(21) Appl. No.: 12/455,435

(22) Filed: Jun. 3, 2009

(51) Int. Cl. H04N 7/025

(52) U.S. Cl. 725/32; 725/113; 725/134

(57) ABSTRACT

For integration of televising advertising with Internet shopping, a link to a web page intended for ordering of advertised product is multiplexed with a stream of video data. At the receiving side, a processor embedded in a set-top box with a USB port detects the link and when the commercial is in progress displays a message prompting a user to save the link. If the user responds, the processor saves the link in a flash drive plugged into the USB port. As a result, the user can watch TV without interruption and shop online at a time of his or her choice by simply pulling the flash drive from the set-top, plugging it into a USB port of a computer with Internet connection and using the link to access the web page for additional information and ordering the product. Optionally, the commercial itself could be recorded on the flash drive and replayed in the computer at the time of online shopping.

### FIELD OF THE INVENTION

This invention relates to convergence of television and the Internet and, more specifically, to integration of televising advertising with Internet shopping.

### BACKGROUND OF THE INVENTION

This invention connects advertising over a conventional one-way television to conventional Internet shopping but its background is more about interactive, i.e. two-way television. The area of interactive TV includes video on demand, interactive program guide and display of Internet content along with a television program.

U.S. Pat. No. 5,832,223 to Hara et al., U.S. Pat. No. 5,929,849 to Kikinis and U.S. Pat. No. 6,058,430 to Kaplan disclose transmission of Internet access information in a television signal.

U.S. Pat. No. 6,061,719 to Bendinelli et al. discloses a system that uses Uniform Resource Locators (URLs) transmitted with television signals in order to present a web content to viewers in synchronization with television programming. A set-top box associated with a television set retrieves a web page and displays both the web page and the corresponding television picture simultaneously using a picture-in-picture (PIP) arrangement. In particular, when a TV advertisement is in progress, a related web page may be displayed to the viewer. The set-top box establishes a connection over the network with a server that delivers the web page. Alternatively, the retrieval device may be a computer that retrieves and displays a web page, while the corresponding television picture is displayed on a television set.

U.S. Pat. No. 6,477,508 to Lazar et al. teaches a system that allows a user to select for purchase products or services presented in a television commercial by simply depressing a button on the remote control during broadcast of the commercial.

U.S. Pat. No. 6,832,388 to Du Val discloses a system that uses a conventional home computer to display information related to television programming. The home computer is connected over the Internet to a web server that receives television signals of all channels and detects URLs embedded into the vertical blanking interval. The user, who is watching television in the same room where the home computer is located, uses a mouse or keyboard to identify the television channel being presently watched to the home computer and this information is transferred over the Internet to the web server. As a result, the web information related to television programming is provided by the server and displayed on the user's computer.

A problem of interactive television is distraction—it is uncomfortable for a user to simultaneously watch a TV program and read web information. U.S. Pat. No. 6,349,410 to Lortz discloses a system for integrating television viewing and web browsing. The system stores a uniform resource locator (URL) to display web content associated with the URL, pauses display of the television content while storing the incoming TV signal stream on a storage device and displays the web content associated with the URL. The system resumes display of the television content at the point where the pause occurred by obtaining the incoming TV signal stream from the storage device. U.S. Pat. No. 7,194,754 to Tomsen et al. discloses a system that defers transactions conducted via interactive television network having connectivity to a data communication network such as the Internet. The system displays a television commercial with an indication that a transaction, such as ordering goods or services, is available and begins the transaction if it receives a user command. If the user does not complete the transaction while the commercial is in progress, the transaction is deferred. The user remote control device is useable to initiate the transaction, to store information related to the transaction, and then to use the information to complete the transaction later.

Using TV screen for Internet access (WebTV) has proved to be inefficient, apparently because of the distance between the user and the screen. U.S. Pat. No. 6,628,729 to Sorensen teaches using a personal digital assistant (PDA) for transferring data, in particular a web link, from a receiver of television signal to a personal computer. For this purpose both the television receiver and PDA are supplemented with IR or RF transceivers for providing data communication between them and in addition, the PDA is to be equipped with a communication port so it could be connected over a cable to a personal computer, which in turn has an Internet connection. Being transferred from the television receiver to the personal computer the web link provides the access to a web site containing additional information about an advertised product or service or may include a coupon for the product. However considering generally negative viewers' attitude to commercials, it is unlikely that many viewers would accept the additional cost of PDA and transceivers, and the trouble of dealing with the equipment on a regular basis. Therefore it is desirable to find a way of combining TV advertising with online shopping that is more convenient for the user.

### SUMMARY OF THE INVENTION

Accordingly, it is the object of present invention to provide a practical way of integration of televising advertising with Internet shopping.

Briefly stated, the inventive system operates as follows. At the transmitting side, it supplements television commercial with a link to a web page intended for ordering of advertised product or service and multiplexes the link with a stream of video data. At the receiving side, it provides a processor embedded in a set-top box with a USB port. The processor detects the link included in the video stream and, when the commercial is in progress, displays a message prompting a user to save the link. If the user responds, the processor saves the link in a flash drive plugged into the USB port. As a result, the user can watch TV without interruption and shop online at a time of his or her choice by simply pulling the flash drive from the set-top, plugging it into a USB port of a computer with Internet connection and using the link to access the web page for additional information and ordering the product or service. Optionally, the commercial itself could be recorded on the flash drive thus providing the user with convenience of replaying the commercial in the computer at the time of online shopping.

The novel features, which are considered as characteristic for the present invention, are set forth in particular in the appended claims. The invention itself, however, will be best understood from the following description of specific embodiment when read in connection with the accompanying drawings.

### BRIEF DESCRIPTION OF THE DRAWINGS

FIG. 1 illustrates user's view of the invention.

FIG. 2 shows a diagram of television system adapted for integration of TV advertising with Internet shopping.

### DESCRIPTION OF THE PREFERRED EMBODIMENTS

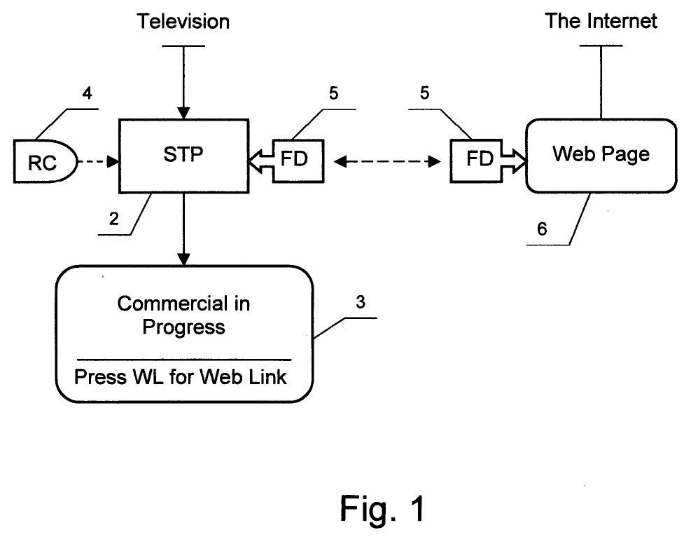

The invention, as it is seen by a user, is illustrated by FIG. 1. A cable or satellite receiver of television signal, traditionally called “set-top box” 2 is provided with a USB port and a USB flash drive 5 plugged into the port. When a commercial is in progress on the television screen 3, a message is displayed at the bottom of the screen prompting the user to press a WL button on the remote control 4 to save a link to a web page that contains additional information about the advertised product or service and electronic order forms. The link is saved in the flash drive 5 so that the user can watch TV without interruption and shop online later, at the time of his or her choice by simply pulling the flash drive 5 from the set-top 2, plugging it into a USB port of a computer 6 with Internet connection and using the link to access the web page in a conventional manner. Optionally, the commercial is also recorded on the flash drive so it could be replayed in computer during online shopping.

USB (Universal Serial Bus) is a standard interface designed to allow many computer peripherals to be connected in “plug and play” manner i.e., by allowing devices to be connected and disconnected without rebooting the computer or turning off the device. Currently many digital set-top boxes have an internal processor and a USB connector. The interface allows connection of a technician's computer to the set-top box for diagnostic purposes. Other uses include connection of digital cameras, game consoles and external hard drives.

A USB flash drive, called also memory stick, is a removable flash memory card with USB interface. It is small—1 to 4 inches and light—less than an ounce, and allows one million write/erase cycles. Nothing actually moves in the device: the term “drive” persists because its read and write operations are the same as for a mechanical disk drive so that the storage is appearing to user as just another drive.

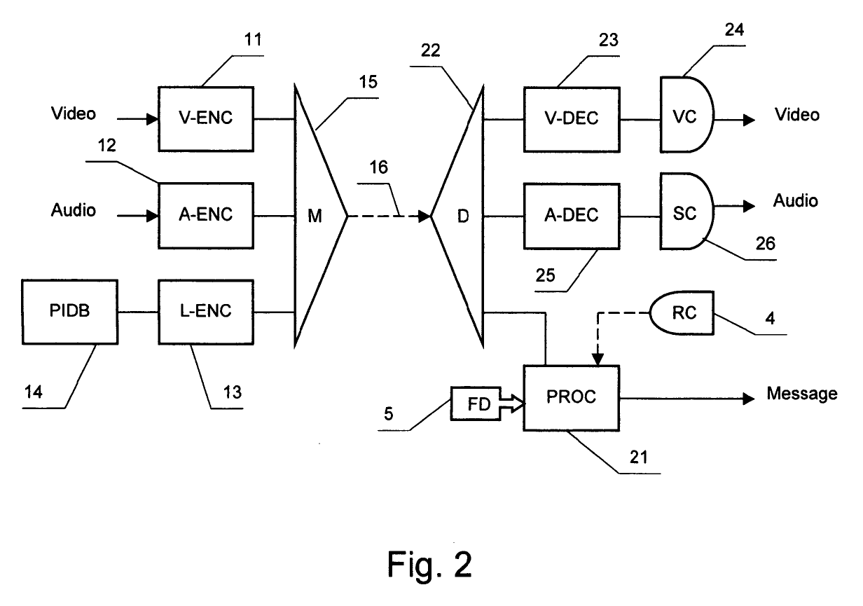

A television system adapted for integration of TV advertising with Internet shopping according to the present invention is illustrated by FIG. 2. The system is operating accordingly to a communication protocol MPEG Transport Stream specified in ISO/IEC standard 13818. The protocol is used in digital cable and satellite television for transmission of compressed moving picture and associated sound and data as a single data stream. MPEG, which stands for Moving Picture Experts Group, is a technique for digital compression of video signal using separate video and audio encoders. The compression reduces the quantity of data used for transmitting and storing digital media.

At the transmitting side, An MPEG-2 encoder 11 converts a digitized video signal into compressed video data and an audio encoder 12 uses an encoding scheme such as MP3 or Dolby Digital AC3 for compressing digital audio. A web link encoder 13 is coupled with a program information database 14 where links to web pages supplementing television commercials are stored together with other program information, in particular, with information used by an interactive program guide. An MPEG-2 transport multiplexer 15 combines video, audio and link data, as well as program guide data, into a single data stream for transmission over a broadcast medium 16 such as cable, satellite or terrestrial TV station.

The receiving side shows components of the set-top box 2 with the remote control 4 and the flash drive 5. An MPEG-2 transport demultiplexer 22 separates video, audio and link/guide data. An MPEG-2 decoder 23 provides video decompression and an MP3 or AC3 audio decoder 25 provides audio decompression. The decompressed video stream is directed to a video card 24, which is a graphics overlay processor responsible for onscreen display generation. The decompressed audio stream is directed to a sound card 26 providing audio synthesis.

A processor 21 embedded in the set-top box and coupled with the USB port detects web links in the program data stream and, when a commercial associated with a link is in progress, displays a message on television screen prompting the user to save the link. If the user responds pressing WL button on the remote control 4, the processor saves the link in the flash drive 5.

All saved links are included in HTML file so technically, no software needs to be installed on the computer side to run this application. But for user's convenience, an application with a shortcut placed on the desktop could be provided. The application would start a web browser, open the HTML file and replay the commercials with right video and audio decoders.

Although the invention is described herein with reference to the preferred embodiment, it is to be understood that modifications can be made by those skilled in the art without departing from the spirit or scope of the invention. In particular, most TV sets have an embedded video receiver so to be able to work without a set-top box. Therefore a USB port and a web link processor can be provided directly to TV set. Accordingly, the invention should only be limited by the claims included below.

1-2. (canceled)

3. A system for integration of conventional television advertising with conventional Internet shopping comprising:
in a television transmitter, means for supplementing a television commercial with a link to a web page designed for ordering a product or service advertised in the commercial, and means for multiplexing the link data with a stream of video data so that the link data could be detected in a television receiver when the commercial is in progress on a television screen; and
in said television receiver, a USB port, a USB flash drive plugged into the USB port and a data processing unit coupled with the USB port, said data processing unit being operative for detecting said link data in the stream of video data when said television commercial is in progress on said television screen, displaying a message prompting a user to save the link and, if the user responds to the message, saving the link in the USB flash drive plugged into the USB port;
thereby enabling the user to watch television without interruption and to shop online in a well-known conventional manner at a time of user's choice by pulling said USB flash drive out of said television receiver, plugging it into a USB port of a computer with Internet connection and using said link saved in the USB flash drive for access to said web page designed for ordering the product or service advertised in the commercial.

4. The system of claim 3 wherein the television commercial itself is recorded onto the USB flash drive thereby enabling the user to replay the commercial in the computer at the time of online shopping.
